(19) United States
(12) Patent Application Publication
(10) Pub. No.: US 2016/0210982 A1
(43) Pub. Date: Jul. 21, 2016

(54) Method and Apparatus to Enhance Speech Understanding

(71) Applicant: Social Microphone, Inc., Palo Alto, CA (US)

(72) Inventors: Kenneth Nathaniel Sherman, Santa Barbara, CA (US); Lin Cong, Stanford, CA (US); David G. Shaw, Nazareth, PA (US); Uwe Kummerow, Imperial Beach, CA (US)

(21) Appl. No.: 15/001,131

(22) Filed: Jan. 19, 2016

Related U.S. Application Data
(60) Provisional application No. 62/104,631, filed on Jan. 16, 2015.

(51) Int. Cl. G10L 21/02; G10L 21/057; G10L 21/013; G10L 21/043

(52) U.S. Cl. CPC G10L 21/0205; G10L 21/043; G10L 21/057; G10L 21/013

(57) ABSTRACT

A personal mobile communications device, such as a smartphone, which increases the intelligibility of the speaker, is described. The speaker reads a specified text into the personal mobile communications device. The specified text audio signals translated into electronic voice signals are compared to electronic voice signals of a predetermined standard speaker. The characteristics in the speaker's electronic voice signals which are different from the characteristics of the electronic voice signals of the standard speaker are determined. Thereafter at least some of the characteristics of the speaker's electronic voice signals are modified toward the characteristics of the electronic voice of the predetermined standard speaker before transmitting the speaker's modified electronic voice signals. The audio signals translated from speaker's transmitted and modified electronic voice signals have increased comprehensibility.

### CROSS-REFERENCE TO RELATED APPLICATIONS

This patent application claims priority to U.S. Application No. 62/104,631, filed Jan. 16, 2015, entitled “Method and Apparatus to Enhance Speech Understanding,” which is incorporated by reference herein for all purposes.

### BACKGROUND OF THE INVENTION

Often, amplified voices are difficult for listeners to understand. This difficulty results from problems at the source, such as poor diction or a heavy accent of the speaker, to problems along the signal path, for example, a speaker turning away from the microphone, a poor microphone, poor audio equipment, poor speakers, crowd noise, air handling noise, difficult room acoustics, all the way to poor hearing on the part of the listener. Any distortion or reduction in volume in the path from the speaker to the ears of the listener creates a concatenation of exacerbating problems.

U.S. Pat. No. 8,144,893, entitled “Mobile Microphone” and assigned to the present assignee, helps to minimize distortion at the source of the sound by allowing the sound to be picked up by a well-positioned microphone (i.e., a cell phone held near the mouth of the speaker, or a head-mounted microphone wired to the microphone input of the phone) and by sending the sound directly through the described system to the microphone input of the public address system. The system's most obvious advantage, other than providing a microphone to each speaker is that it eliminates any room noise, and reverberations that a distant microphone would pick up along with the speaker's voice.

This invention improves the ability of humans and computers to understand spoken speech. In addition to properly “miking” a speaker, such as described in the patent cited above, the prior art creates improved speech discrimination for the listener in three fundamental ways. The three ways employed are: (1) selecting speakers whose natural voice quality, diction and accent are easier for a given audience to understand; (2) adjusting the amplitude of all or specific frequencies of a speaker's voice before it is broadcast or transmitted; and (3) for computer voice recognition, providing a computer with a customized dictionary that matches an individual's pronunciation to known words.

The invention presents another way which changes the speech signal at its source in ways that are (a) customized to the speaker to increase speech discrimination by listeners and (b) preferably introduced before any other signal processing is applied to the signal so that all further signal processing has a clearer signal on which to work. Speech discrimination can be idealized for a general audience, a selected audience or even a computer.

### BRIEF SUMMARY OF THE INVENTION

The present invention provides for a method of increasing the comprehensibility of speech spoken into a personal mobile communications device, such as a smartphone. The method comprises: receiving audio signals from a speaker reading a specified text into the personal mobile communications device; translating the specified text audio signals from the speaker into electronic voice signals; comparing the speaker's electronic voice signals to electronic voice signals of a predetermined standard speaker; determining characteristics in the speaker's electronic voice signals different from the characteristics of the electronic voice signals of the standard speaker; thereafter upon receiving audio signals from the speaker and translating the audio signals into electronic voice signals, modifying at least some of the characteristics of the speaker's electronic voice signals toward the characteristics of the electronic voice of the predetermined standard speaker; and transmitting the speaker's modified electronic voice signals; whereby the audio signals translated from speaker's transmitted and modified electronic voice signals have increased comprehensibility.

The present invention provides for a personal mobile communications device comprising a computer processing unit and a memory unit holding data and instructions for the processing unit to perform the following steps: upon receiving audio signals from a speaker into the personal mobile communications device, translating the audio signals into electronic voice signals; modifying at least some of the characteristics of the speaker's electronic voice signals toward the characteristics of the electronic voice of the predetermined standard speaker, the characteristics in the speaker's electronic voice signals determined to be different from the electronic voice signals of a predetermined standard speaker; and transmitting the speaker's modified electronic voice signals; whereby the audio signals translated from speaker's transmitted and modified electronic voice signals have increased comprehensibility.

Other objects, features, and advantages of the present invention will become apparent upon consideration of the following detailed description and the accompanying drawings, in which like reference designations represent like features throughout the figures.

### DETAILED DESCRIPTION OF THE INVENTION

Existing research has identified specific characteristics of a person's speech (such as speaking speed, pauses, and pitch) and how people voice certain parts of speech that results in speech that is of varying degrees of intelligibility: 1) speaking rate; 2) number of pauses; 3) pause duration; 4) consonants' and vowels' length; 5) acoustic vowel spaces; and 6) loudness. What makes speech more intelligible: 1) speech is generally slower (although not too slow); 2) key words are emphasized; 3) pauses are longer and more frequent; 4) speech output exhibits a greater pitch range; 5) speech is generally at a lower pitch; 6) stop bursts and nearly all word-final consonants are released, and the occurrence of alveolar flapping is reduced; 7) consonants and vowels are lengthened; 8) consonant-to-vowel intensity ratio is greater; 9) acoustic vowel spaces are expanded and the first formant of vowels (F1) tends to be higher; 10) fundamental pitch frequency (FO) mean and range values tend to be greater, while the fundamental pitch frequency does not exceed a certain maximum; and 11) speech is louder. (The long-term spectra of clear speech are 5-8 dB louder than that of conversational speech.)

Characteristics which make speech less intelligible are: 1) speech that is too fast (technically called cluttering); 2) speech that contains unnecessary, sometimes redundant, sounds; 3) speech that blurs words and sounds together; 4) speech that is produced from the back of the throat; 5) speech that is produced through the nose and not through the lips including what is called “hypo nasal” with little or no nasality—like someone with a cold, “hyper nasal,” which has too much nasality and what is called “mixed,” which, depending on the speaker, has a little too much of hypo and hyper.; 6) speech formulated by profoundly deaf people who have never heard it produced correctly; and 7) speech formulated by non-native speakers who when they were young did not hear the sounds of the language they are trying to speak. People whose speech is affected by inability to hear certain sounds when they were learning to speak often have difficulty with “s,” “sh,” and “ch.”

Speech formulated by non-native speakers has its own subset of common issues stemming from the fact that allophones are different in different languages. Usefully, differences from English are often predictable in that onset timing is different for similar consonants, and vowels have different formant spacing and structure. A common problem for some speakers who have not learned English at an early age is substituting “r” and l.

Another class of speech dysfunction comprises physically caused distortions, including a Lisp (both tongue and lateral—breathy speech); a Stutter (not likely candidate for this system); Dysarthria (more common in older people and Parkinson's patients); Tremor speech (common in older people—Spasmodic or Flaccid); Hyper kinetic; Hypo kinetic; Whispering; Raspy or airy speech (caused by speech nodules, polyps or granuloma—common in singers, teachers and people who speak for a living. These physical or medical issues cause issues with pure pitch production. They may cause complete lack of glottal pulses. They may cause substitutions such as missing “r”s (derhotacization) such as Wabbit instead of rabbit,“hunting waskilly wabbits” “mawwaige is what bwings us togeva today”, Razalus instead of Lazarus (common with people from Africa and parts of Asia), “Z” instead of “th” and others such as Sh, K and Ch.

Intelligibility for clear speech depends on well-understood phoneme identification. A phoneme is the smallest distinctive unit of a language. Phoneme identification depends on well-understood perceptual cues used by the auditory system to discriminate between and among the various classes of speech sounds. Each class of sound possesses certain acoustic properties that make each class unique and easily capable of discrimination from other classes. Existing algorithms used in digital speech processors and computer central processing units are capable of two types of function. First, they can detect the presence of a phoneme. Second, they can change the characteristics of the phoneme by signal processing tools, such as selectively increasing or decreasing energy (volume), frequency filtering, and repeating sounds or selectively eliminating sounds. Examples of these changes are given below.

Intelligibility also depends of the pitch of the voice, particularly the fundamental pitch frequency (FO). Pitch can be changed in real-time. Furthermore, the fundamental pitch frequency is an excellent example of a speaker-dependent feature that can be determined in advance.

Intelligibility also depends on the sound level or volume of the speech. Obviously, a speaker who is speaking too softly to be understood should have his or her volume increased, and that can be done in real-time. But, perhaps less obviously, many talkers change their volume while speaking. They often drop their voice at the end of a sentence, particularly at the end of a statement. They also move the microphone back and forth as they speak, usually moving it away as they continue to speak or when they pause, forgetting to bring it back to their mouth. This characteristic behavior is also speaker-dependent.

The present invention recognizes that current research allows speech characteristics, such as vowels, consonants and other things, to be modified to make speech more intelligible. Vowels may be changed to increase intelligibility: 1) a vowel's amplitude or intensity is changed: 2) the spectral distance between a vowel's formant frequencies are changed; 3) a vowel's formant space, such as formant frequency F1 and F2 is changed; and 4) a vowel's formant level ratio is changed. Consonants may be changed to increase intelligibility: 1) a consonant's amplitude or intensity is changed; 2) the spectral distance between a consonant's formant frequencies are changed; 3) a consonant's formant space, such as formant frequency F1 and F2 is changed; 4) a consonant's formant level ratio is changed; 5) a consonant's sub band amplitude is changed; 6) a consonant's duration is changed; 7) a fricative's duration is changed; and 8) unvoiced and voiced fricatives are modified to be more distinguishable from each other. Speed, pitch and loudness may be changed to increase intelligibility: 1) generally, words that are spoken too quickly can be drawn out, with the pitch corrected in a process sometimes referred to as “slow voice”; 2) pauses that are missing between words or are too brief can be inserted or lengthened; 3) the fundamental pitch frequency can be increased or decreased; 4) key words can be emphasized; 5) automatic gain control and dynamic range compression can be used to prevent the loss of intelligibility that comes when a speaker drops his or her volume (often at the end of a sentence) or moves the microphone out of optimum range; and 6) sub-word units, (or “sub-words”) can be selectively enhanced. An example is increasing the energy of beginning or trailing fricatives.

With the present invention a speaker's variation from ideal is identified within each type of formant and, as it is being produced, the formant is corrected while it is being produced. The correction is usually an increase in, or diminution of strength of the signal, at specific frequencies. It can also consist of repeating information, in order to elongate a vowel for example, or eliminating information that is distracting.

The present invention also recognizes that the current personal mobile communications device found on persons everywhere is basically a computer with telephone capability, i.e., what is often termed a smartphone. This allows the speech intelligibility function to be customized to the holder of the smartphone. Since the phone belongs to an individual, it is therefore practical to introduce customized changes to the speech signal that adjust the individual's voice output to maximize speech understanding. The phone's processing modifies the signal sent from the phone to adjust the sound of the individual's voice so that the average listener in the room will better understand what the individual is saying.

The customized changes are initialized by the individual reading a supplied text into an app in the individual's phone or into a system in the cloud. The system in the cloud or the app compares the individual's speech with an idealized standard across many specific parameters discussed below. With the comparison, the system or app determines the changes that should be made to the individual's voice signal to bring the voice quality closer to the ideal or predetermined standard so that a listener can “clearly hear” and understand what the individual is saying. The changes, applied in real time by the individual's smartphone to the voice signal, bring the voice signal closer to that of an ideal speaker from the standpoint of speech clarity. The speaker does not sound the same as he or she would have sounded without the changes; in fact, the speaker's voice may sound robotic and not be identifiable to those who know the speaker.

As a result, the voice is easier to understand and possibly more pleasant. But as the changes required for that individual become more extensive, the voice sounds less and less like the individual. One alternative in practice is that the individual can choose only a partial “correction” so that his or her voice still sounds familiar. The degree of processing is adjustable to allow a compromise between speech clarity, on the one hand, and naturalness, speaker identity, and low-latency on the other.

The changes can be selected to help all listeners in difficult hearing situations and/or only hard-of-hearing listeners and can also be modified according to room characteristics, selectively, or even automatically using a feedback loop/algorithm.

To modify the speaker's voice, computerized processing effects the changes particular to the quality of a speaker's voice. The changes are made in the electronic circuit after the analog voice signal is digitized and before it reaches the public address system. The changes in the speaker's voice are designed to enhance a listener's ability to understand what the speaker is saying—what is referred to as “clear speech.” These changes include but are not limited to: a) decreasing the speaking rate, such as inserting pauses between words and/or stretching the duration of individual speech sounds; b) modifying vowels, usually by stretching them out; c) releasing stop burst and all word-final consonants; d) intensifying obstruents, particularly stop consonants, and e) reducing the long-term spectral range (rather than emphasizing high frequencies).

To determine the changes for an individual speaker, the speaker reads a provided text into his/her smartphone's microphone. An app in the smartphone or the “cloud” compares the speaker's voice with an ideal voice which provides a standard to determine the necessary changes. The speaker's voice is compared against the attributes of “clear speech,” i.e., an ideal voice represented by a set of predetermined speech attributes which enhance a listener's ability to understand the speaker. These attributes are created from a database of one or more speakers who are deemed to be easily understood by listeners, such as newscasters, announcers, and other persons with “clear speech.” Such databases are available from academia and from speech technology companies, or can be created. Among the characteristics of clear speech are emphasis of key words, longer and more frequent pauses, greater pitch range, stop bursts and the release of nearly all word-final consonants, the reduction of alveolar flapping, lengthening of consonants and vowels, increase in consonant-to-vowel intensity ratio, expansion of acoustic vowel spaces, higher first formant of vowels and fundamental frequency mean, and greater range values, and other features. The attributes of a clear speech speaker are compared with those of the individual speaker using computer algorithms with tools, such as MATLAB, to generate the changes necessary for the speaker's voice to duplicate or at least approximate that of the ideal speaker.

The changes are applied to the speaker's voice when the speaker uses the phone. The changes are applied in real time, preferably immediately after the microphone and immediately proximate the analog-to-digital converter to provide the cleanest signal for processing the speech. The changes are applied in some weighted fashion based upon: 1) the effectiveness of a change; 2) the requirements of processing time to effect a change; and 3) the amount of loss of the speaker's original voice from a change. Stated differently, these considerations are: 1) how well did a change make the speaker's voice intelligible; 2) does a change require a lot of computing time from the smartphone; and 3) how different or strange does the speaker's voice sound with a change. All these considerations must be balanced against each other before effecting a change.

Other sources of changes for application to a speaker's voice may be possible. For example, results from the following: a) machine learning and deep learning with neural networks, such as querying IBM's neuro-synaptic Watson; b) acoustic modeling using discriminative criteria; c) microphone array processing and independent component analysis using multiple microphones; and d) fundamental language processing, speech corpus utilization and named entity extraction, may lead to additional insight into the nature of “clear speech” and provide changes to apply to a speaker's voice. Such changes can supplement or replace some of the changes described above to better render a speaker's voice as clear speech.

A further application of the present invention is that it can be adapted to speech recognition. Individual differences in vocal production and speech patterns, regional accents, and possibly even to some extent, habitual distance from the microphone are automatically taken into account when a speech recognition program learns the idiosyncratic speech of a user by having the user “train” the program. In this instance, the user “trains” the program by reading text aloud into the program. The program matches the sounds the speaker makes with the text to build a file of word sounds or even word sound variations the speaker produces. The program can then use this knowledge to understand a speaker even though his speech would not generate a correct word match using a standard speech-to-text dictionary. By using the clear speech changes described above, the input into speech recognition programs is improved. The clear speech program modifies the speaker's voice toward an easily understood voice before the speech recognition program is engaged.

The corrections introduced by the present invention can be modified to enhance computer understanding; the computer may need a complement of sounds different from sounds optimized for humans for accurate understanding. In fact, a population of listeners raised on different languages, such as tonal languages, may need still a different complement of sounds for accurate understanding.

It is also possible to supply a dedicated processer that performs the same processing to broadcasters and others who want to use a professional microphone. In this case, the individualized processing is provided at the same position in the audio chain. In this case, there will be some precedent, in that some performers use pitch changing to correct singers who are out of tune, and of course, variable gain is used to lift the volume as soon in the audio chain as practical.

The present invention is suitable for automatic speech recognition and for telephone calls when the user is using his cell phone. Robust speech recognition may be a requirement for data analytics. If the phone owner wants his or her voice to be understood, he or she can utilize the voice changing technology described here to make it possible for a speech recognition system to understand what he or she is saying.

The system can also send a second stream of data to enable a computer to authenticate the identity of the speaker based on a match of some or all of the parameters that the system identified as varying from the ideal when the speaker originally spoke the prepared text into the system.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A personal mobile communications device comprising:
a computer processing unit; and
a memory unit holding data and instructions for the processing unit to perform the following steps:
upon receiving audio signals from a speaker into the personal mobile communications device, translating the audio signals into electronic voice signals;
modifying at least some of the characteristics of the speaker's electronic voice signals toward the characteristics of the electronic voice of the predetermined standard speaker, the characteristics in the speaker's electronic voice signals determined to be different from the electronic voice signals of a predetermined standard speaker; and
transmitting the speaker's modified electronic voice signals;
whereby the audio signals translated from speaker's transmitted and modified electronic voice signals have increased comprehensibility.

2. The personal mobile communications device of claim 1 wherein the device comprises a smartphone.

3. The personal mobile communications device of claim 1 wherein at least some of the characteristics modifying step comprises slowing the speaking rate.

4. The personal mobile communications device of claim 1 wherein at least some of the characteristics modifying step comprises stretching out vowel sounds.

5. The personal mobile communications device of claim 1 wherein at least some of the characteristics modifying step comprises releasing stop burst and all word-final consonants.

6. The personal mobile communications device of claim 1 wherein at least some of the characteristics modifying step comprises intensifying obstruent sounds.

7. The personal mobile communications device of claim 1 wherein at least some of the characteristics modifying step comprises reducing the long-term spectral range of the electronic voice signals.

8. A method of increasing the comprehensibility of speech spoken into a personal mobile communications device comprising:
receiving audio signals from a speaker reading a specified text into the personal mobile communications device;
translating the specified text audio signals from the speaker into electronic voice signals;
comparing the speaker's electronic voice signals to electronic voice signals of a predetermined standard speaker;
determining characteristics in the speaker's electronic voice signals different from the characteristics of the electronic voice signals of the standard speaker;
thereafter upon receiving audio signals from the speaker and translating the audio signals into electronic voice signals, modifying at least some of the characteristics of the speaker's electronic voice signals toward the characteristics of the electronic voice of the predetermined standard speaker; and
transmitting the speaker's modified electronic voice signals;
whereby the audio signals translated from speaker's transmitted and modified electronic voice signals have increased comprehensibility.

9. The method of claim 8 wherein the personal mobile communications device comprises a smartphone.

10. The method of claim 8 wherein the electronic voice signals comparing and characteristics determining steps are performed by processing removed from the personal mobile communications device.

11. The method of claim 10 wherein the processing is performed in the cloud.

12. The method of claim 8 wherein at least some of the characteristics modifying step comprises slowing the speaking rate.

13. The method of claim 8 wherein at least some of the characteristics modifying step comprises stretching out vowel sounds.

14. The method of claim 8 wherein at least some of the characteristics modifying step comprises releasing stop burst and all word-final consonants.

15. The method of claim 8 wherein at least some of the characteristics modifying step comprises intensifying obstruent sounds.

16. The method of claim 8 wherein at least some of the characteristics modifying step comprises reducing the long-term spectral range of the electronic voice signals.
